(19) United States
(12) Patent Application Publication
(10) Pub. No.: US 2006/0016046 A1
(43) Pub. Date: Jan. 26, 2006

(54) Gate hanger - hinging kit / process

(76) Inventors: Edwin Hambly Koert, Naples, FL (US); Edward John Merritt, Naples, FL (US); Randy Joe Wright, Naples, FL (US)

Correspondence Address: Edwin H. Koert, 5940 English Oaks Lane, Naples, FL, 34119, US

(21) Appl. No.: 10/899,494

(22) Filed: Jul. 26, 2004

(51) Int. Cl. E05D 13/00; E05D 15/00

(52) U.S. Cl. 16/86.1

(57) ABSTRACT

A gate hanger—hinging kit/process, hinges a gate to a vertical support structure, such as a post, concrete column, I-Beam, etc. (herein after a “Post”), at an installation site where the support post projects vertically in an upward direction from a surface having a first surface portion extending laterally, the gate hanger kit encompassing four independent, and inter related components, such as, a gate mounting and support bracket, a special polymer insert bushing, a three-dimensional bolt apparatus, and a mounting plate for a support post, providing horizontal swinging axis, when all such related components are used in the gate hinging process, such as, two mounting plate secured to a post, one plate located on the upper portion of the post and a second plate located on the lower portion of the post, and both plates have a three-dimensional bolt attached and secured thereto, two gate mounting and support brackets welded to the gate vertical brace post, at locations approximating those of the mounting plates and three-dimensional bolt, and having the special polymer inserts bushings placed within the recessed areas of the gate mounting and support bracket, with respect to the post, relative to the first location, a bracket mounting the gate to the hinge for swinging movement about the hinge axis between a closed position and an open position, the gate mounting and support bracket having a support area, with insert bushing for mounting the gate upon the vertical bolt portion of the three-dimensional bolt apparatus, thus, East/West swinging hinge axis in relation to the support post North South vertical position.

### CROSS-REFERENCE TO RELATED APPLICATIONS

This application is related to:

1). Design Patent Application request:
Gate Hanger—Gate Mounting and Support Bracket (Piece Part of Hinge process) Documents enclosed herein.

2). Design Patent Application request:
Gate Hanger—Three-Dimensional Bolt Apparatus Documents enclosed herein.

3). Design Patent Application request:
Gate Hanger—Mounting Plate for Steel Post Documents enclosed herein.

### STATEMENT REGARDING FEDERALLY SPONSORED RESEARCH OR DEVELOPMENT

None—NA.

### REFERENCE TO SEQUENCE LISTING, A TABLE, OR A COMPUTER PROGRAM LISTING COMPACT DISK APPENDIX

None—NA.

### BACKGROUND OF THE INVENTION

1. Field of the Invention

This invention broadly concerns a gate hanger—hinging kit/process for large, heavy, long tongue residential and or commercial ingress/egress security swing gates and the required engineered and designed hardware equipment that is used to secure such a gate to a support post, level such a gate, support the weight of such a gate, and physically separate the metal components from each other and provide anti-friction free floating movement when the gate is swung to the open position or swung to the closed, secure position.

2. Description of the Prior Art

Gates have been in used throughout history, for security purposes and for aesthetic purposes, such as access to castles, access to ranch land, across walkways, and for securing drive paths to residential and or commercial property, all of which have evolved over time, such as, J-Hooks and O-Bolts, flat plate folding brackets, to grease fitting mating blocks with a bearing and removable center bolt. While they have all worked for their intended purpose, each have had physical restrictions imposed upon them over time, such as, metal to metal friction, pull strength and weight support, leveling and restricted movement.

Accordingly, the present invention solves and provides the solution for hinging and leveling large, heavy, long tongue ingress/egress residential and or commercial security swing gates. The engineered and designed hinging kit, through its hardware equipment provides the structural integrity required to support such a gate, such as, leveling, North/South vertical weight support, East/West pull strength support, and free floating anti-friction swing action movement while maintaining a gate parallel to a ground surface.

### BRIEF SUMMARY OF THE INVENTION

The present invention gate hanger—hinging kit/process hereof uses a minimum of components, provides great flexibility in operation and is simple to install. The hinging process provides versatility and ease of adjustment for accommodating a wide variety of installations, thereby promoting widespread use; exhibits a relatively simple design for economical manufacture and ease of use; provides a relatively rugged construction for structural integrity and outstanding performance over an extended service life.

Broadly speaking, the gate hanger—hinging kit/process hereof permits the gate to remain level and upright in a closed position and level and upright while swinging to the open position. These and other advantages will become apparent, appreciated and understood more fully by those skilled in the art with reference to the drawing and the following description of the preferred embodiment.

### BRIEF DESCRIPTION OF THE SEVERAL VIEWS OF THE DRAWINGS

FIG. 1 is a front elevation view of a gate in an East/West vertical position, installed on a post, utilizing the gate hinging kits associated hardware, and constructed in accordance with the present invention. The view is at the 100 ft., stand back distance area to afford the public with a better understanding of the size and type of gate, and with the area of focus indicated on the diagram;

FIG. 2 is an enlargement of the area that was indicated as “Area of Focus” on FIG. #1, with the gate bracing post leg on the left, the steel support post on the right, and the hinging kit hardware in the center, consisting of:

#1 the Mounting and Support Bracket welded to the gate support leg, and

#2 the Special Polymer Insert, for free floating anti-friction movement, and

#3 the Three-Dimensional Bolt Apparatus, for gate support and post attachment, and

#4 the Mounting Plate for the Steel Post support structure;

FIG. 3 is an enlargement of the mounting and support bracket, indicated as #1 within FIG. #1, providing all of the cross-sectional views, of said bracket,

FIG. 4 is an enlargement of the special polymer insert bushing, indicated as #2 within FIG. #1, providing all of the cross-sectional views, of said bushing;

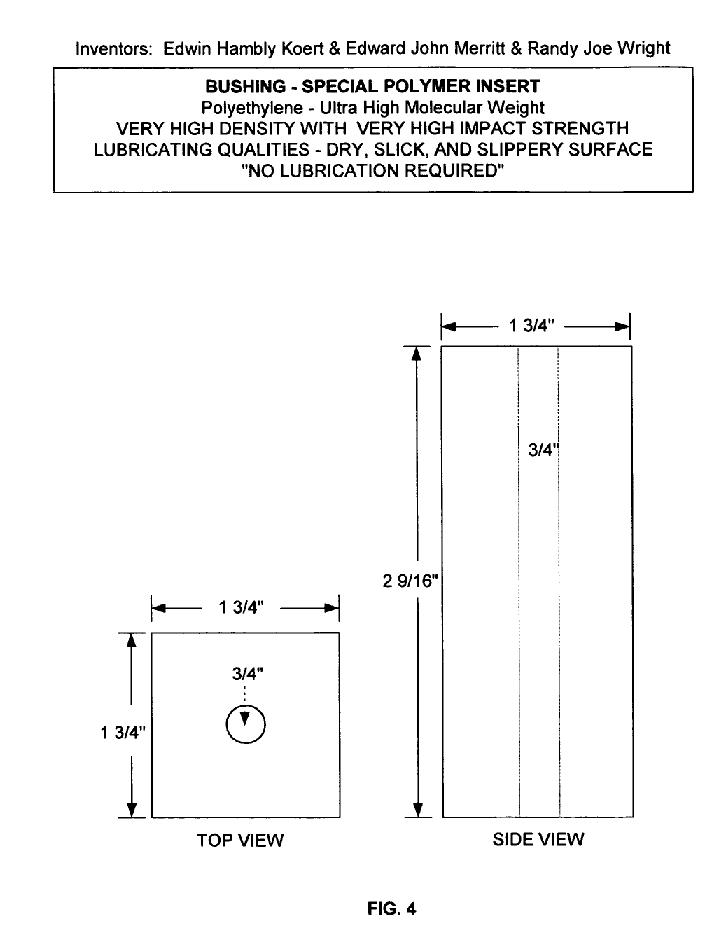

FIG. 5 is an enlargement of the three-dimensional bolt apparatus, indicated as #3 within FIG. #1, providing all of the cross-sectional views, of said bolt;

FIG. 6 is an enlargement of the three-dimensional bolt apparatus, with comments to provide the public with additional understanding of its finctional utility;

FIG. 7 is an enlargement of the mounting plate for a steel post, as indicated as #4 within FIG. #1, providing all of the cross-sectional views;

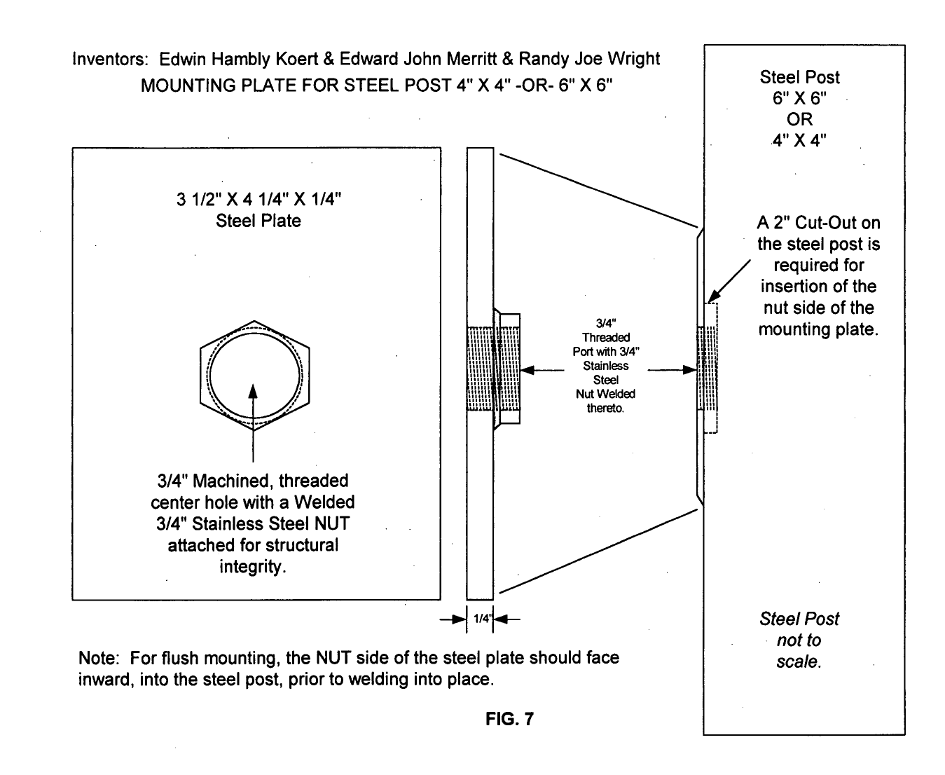

FIG. 8 is an enlargement of a mounting plate that would be used on a concrete column vs steel post.

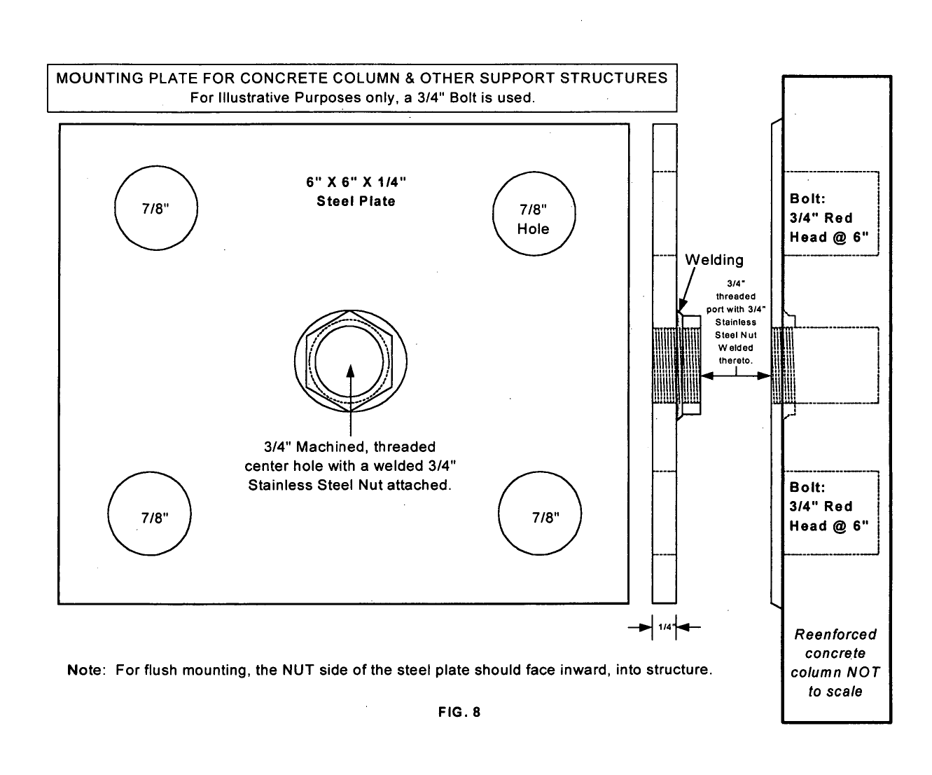

FIG. 9 is a view of the preferred embodiment.

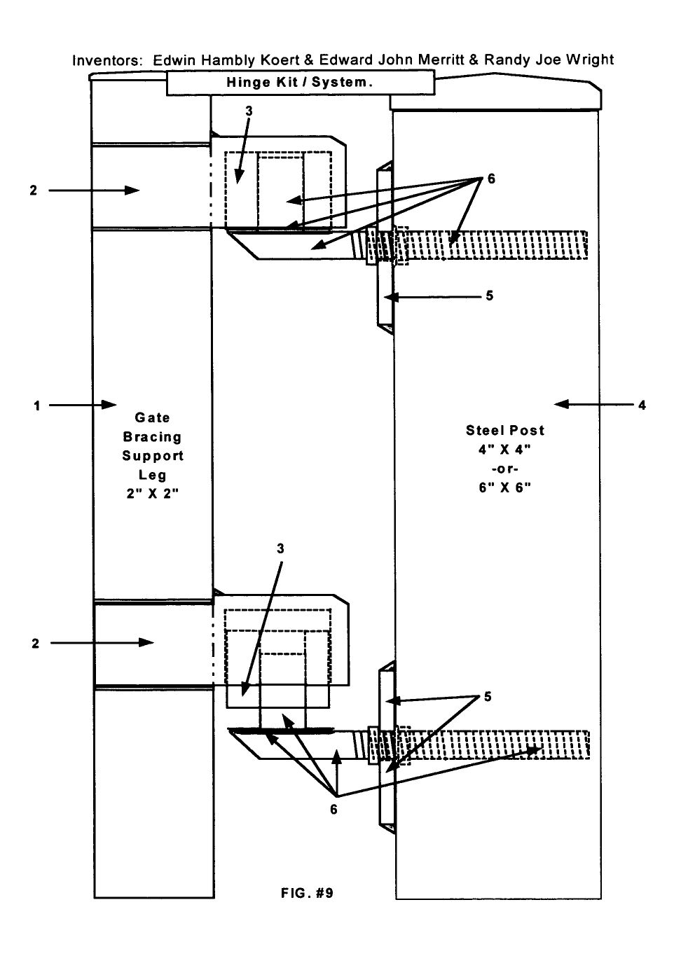

### DESCRIPTION OF THE PERFERRED EMBODIMENT

A gate hanger—hinging kit/process, in accordance with the present invention broadly includes 1 a gate vertical brace post, 2 a gate hanger—mounting and support bracket, 3 a bushing—special polymer insert, 4 a three-dimensional bolt apparatus, 5 a gate hanger—mounting plate for a steel post, and 6 a steel support post, each hardware component of which is used in series with each other to form and complete the hinging process.

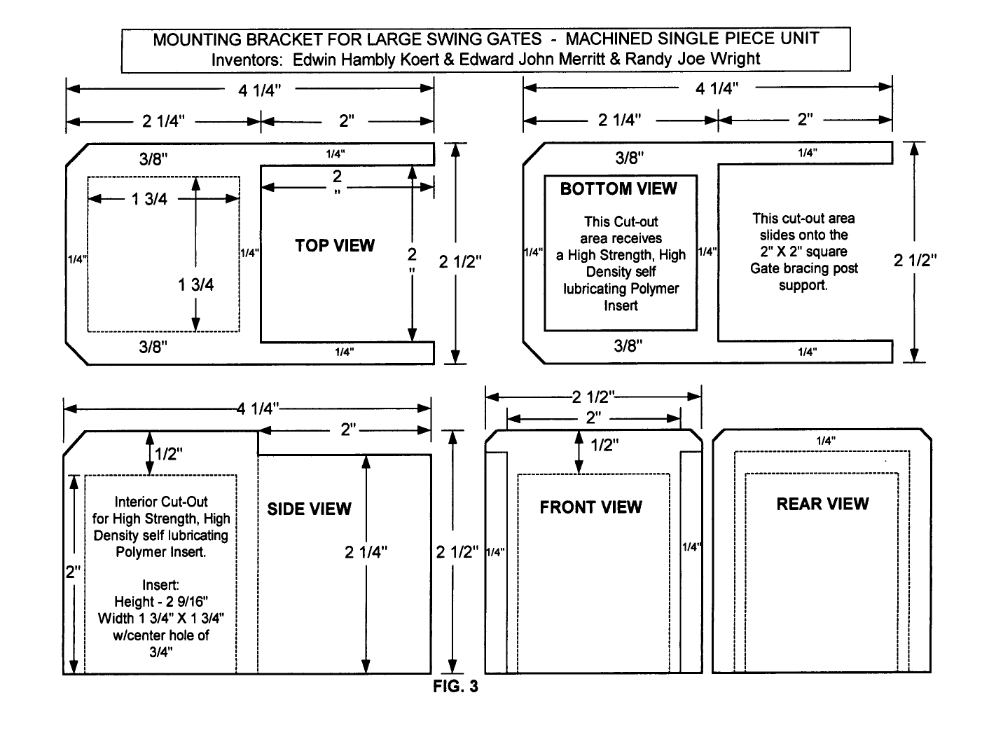

In greater detail as shown in FIG. 3, the Gate Hanger—Mounting and Support Bracket is welded to the gate post 1 with the flat top surface of the bracket, orientated North, upward, and the flat East/West protruding arm plates of the bracket placed over the East and West face of the vertical gate post leg, of a gate aligned in a North/South direction, thus, the machined, hollowed out portion of the mounting and support bracket extends to the rear of the gate, faces downward, and in position to receive 3 a Bushing—A Special Polymer Insert, orientated so that the bushing insert's center hole is exposed when inserted within the bracket opening. The steel structural support post 4 is in place, with two, approximately two inch ports ready for attachment of the two 5 Steel Mounting Plates. For flush mounting to the steel post 4, the steel mounting plates 5, is welded to the post, with the face having the extended threaded surface area, the nut, positioned inward to the post. The Three-Dimensional Bolt Apparatus 6, having a jam nut screwed onto the horizontal threaded bolt, in close proximity to the circular flat base area, prior to attachment, via the port area of the steel mounting plates 5. The Three-dimensional Bolt Apparatus 6 is screwed into the steel mounting plate 5 to within approximately 1″ of the flat circular surface area of the bolt, thus, providing the clearance that allows swing action clearance of the Mounting and Support Bracket 2 head when attached. When the Three-Dimensional Bolt Apparatus 6 is in place, with the vertical smooth bolt portion pointing upward, the bottom unit jam nut is tightened to secure the bolt in its current upright place. The top jam nut is finger tight to hold the top bolt in place during the leveling phase. The gate's Mounting and Support Brackets 2 are placed upon the two three-dimensional bolts, vertical smooth bolt 6. Leveling adjustments, if required, is accomplished via the top three-dimensional bolt6, by screwing the bolt inward, into the steel mounting plate 5 to elevate the gate tongue tip, or screwing the bolt outward to lower the tongue tip. The lower bolt jam nut keeps the lower bolt fixed, in place during the leveling adjustment process.

Minor adjustment for physical contact between the two hinging surfaces, such as, the circular flat support area of the three-dimensional bolt 6 and the mounting and support bracket 2, and the bushing polymer insert 3 surface may vary an ⅛^{th} of an inch. This variance can be corrected by the use of a shim, having the same diameter and thickness of the circular flat surface area of the bolt, thus, providing equal gate weight distribution upon the surface of both bolts.

Although preferred forms of the invention have been described above, it is to be recognized that such disclosure is by way of illustrations only, and should not be utilized in a limited sense to interpreting the scope of the present invention.

The invented hinging process and hardware as shown and described in FIG. #1 through #9 is an innovative straightforward process, engineered and designed for those skilled in the art of building and installing such gates. Engineered and designed for:
Structural integrity.
Kit form (process and hardware components).
Understanding.
Simplicity.
Ease of modification/adjustment (weight bearing & leveling).
Recurring Maintenance.
Installation.

Obviously, modifications to the exemplary embodiments, as set forth hereinabove, could be readily made by those skilled in the art without departing from the spirit of the present invention.

I, We the inventors hereby state our intention to rely on the Doctrine of equivalents to determine and assess the reasonably fair scope of our invention as it pertains to any apparatus not materially departing from but outside the liberal scope of the invention as set out in the following claims.

I, We claim:

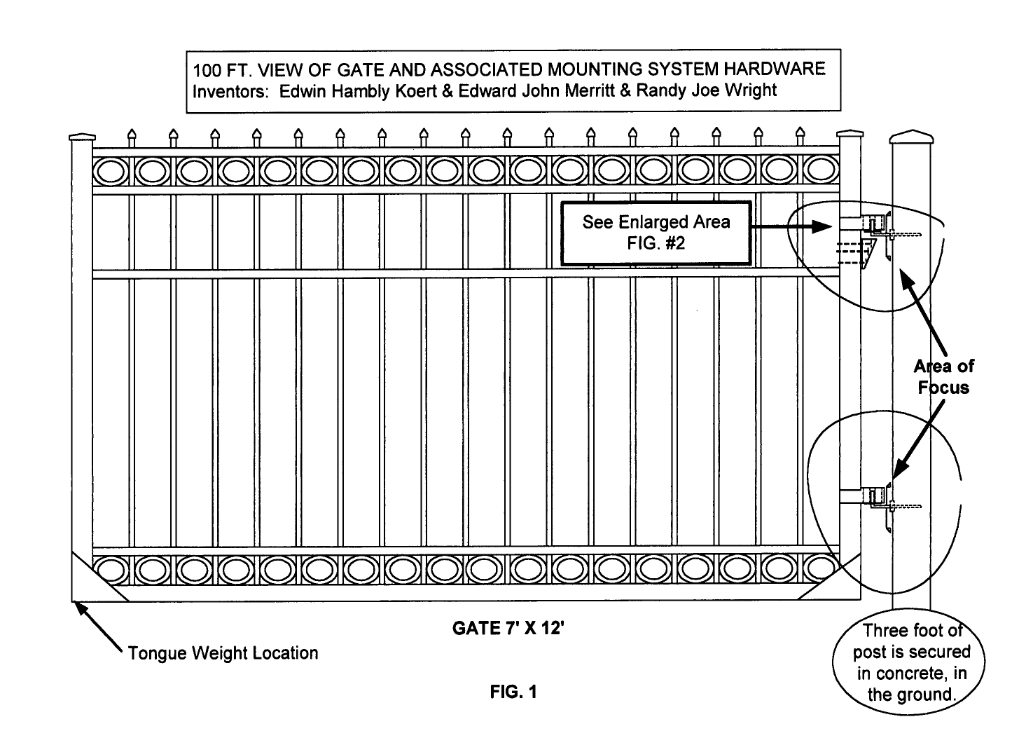

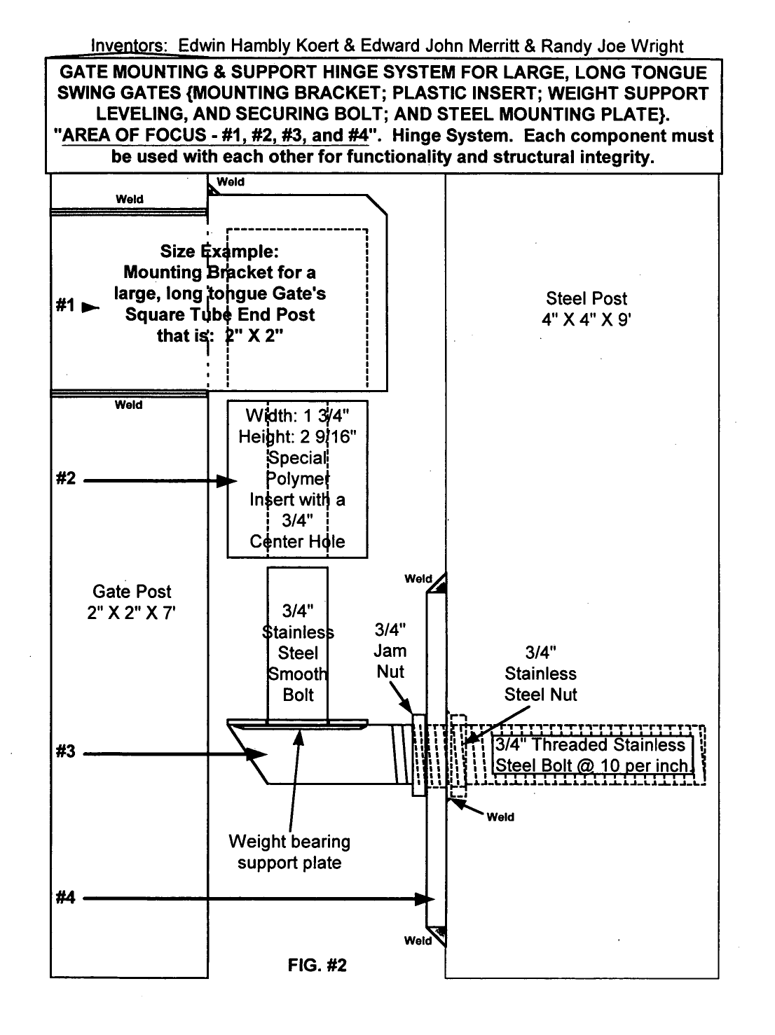

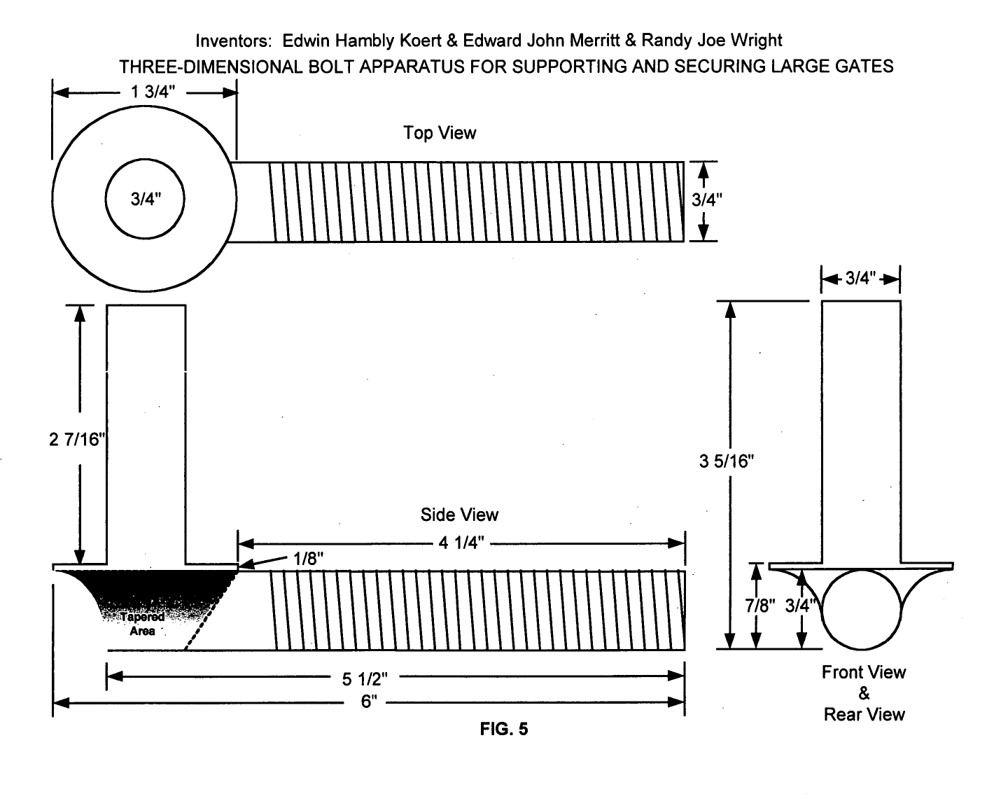

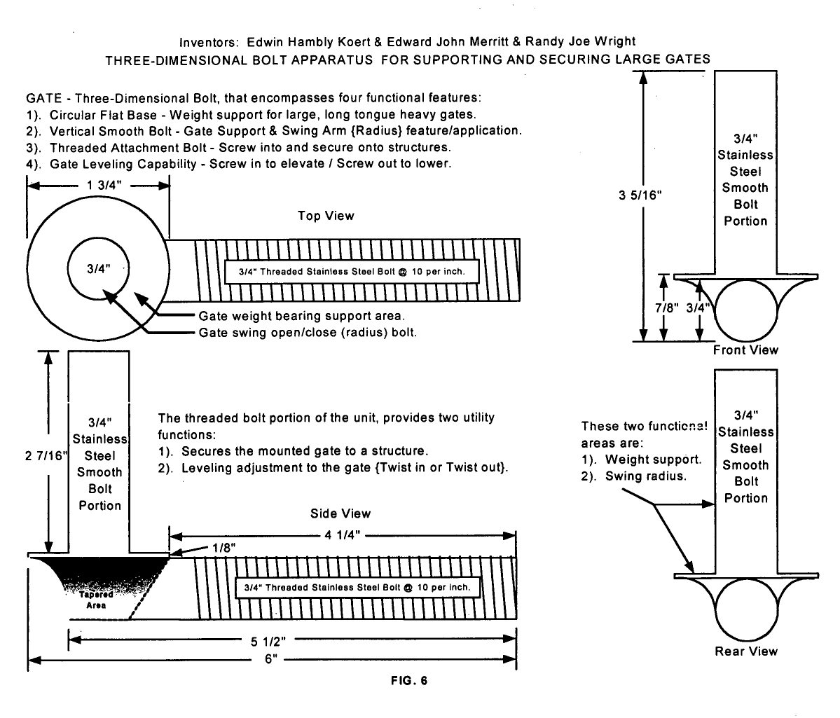

1. A Gate Hanger—Hinging Kit/Process for pivotally mounting a large, heavy, long tongue, residential and or commercial ingress/egress security swing gate to a support structure, such as, a post, concrete column, I-Beam, etc. (herein after a “Post”), said gate, with which the kit is to be used, having a gate vertical bracing support leg, with two designated, marked areas to which two gate hanger are attached thereto, said gate hanger—hinging kit/process comprising of:
a gate hanger—gate mounting and support bracket, having two protruding flat plates that are slid over both sides of the gates vertical bracing support leg and welded in place thereto, one bracket on the upper portion of the vertical gate support leg and the second one welded on the lower portion of the gate support leg, and having a protruding mounting head portion of the bracket that extends beyond the gate's vertical support leg, containing a machined cut out area for insertion of a bushing—a special polymer insert, encompassing all of the design features as shown and described in FIGS. #1, #2, and #3, and
a bushing—a special ultra high molecular weight polymer insert, for each mounting and support bracket, having outstanding impact strength, weight bearing qualities, and a slick, slippery surface, that provides excellent anti-friction floating movement, rotational, sliding or swinging between two weight bearing metal surfaces, and having a pre tapped center port for placement over and around a vertical smooth bolt, thus, physically separating two metal surfaces, as well as, becoming the demarcation and mating point between such two metal surfaces, such as, the gate's mounting and support bracket and the circular, flat weight bearing area of the three-dimensional bolt apparatus, the attachment and support bolt, encompassing all of the design features as shown and described in FIGS. #1, #2, and #4, and
a gate hanger—three-dimensional bolt apparatus with three independent physical features, encompassing all of the design features as shown and describe in FIGS. 1, 2, 5, and 6, such as:
a vertical smooth bolt for insertion into the center port of the bushing, when recessed within the mounting and support bracket, thus, maintaining a gate in a vertical position, and also providing free floating, anti-friction swing gate movement when swung into an open position or into a closed position,
a circular, flat, weight bearing base plate surface that the gate's mounting and support bracket, with polymer insert, is mounted upon, for anti-friction floating movement,
a horizontal threaded bolt area for screwing the apparatus into gate hanger—mounting plate for a steel post, thus, becoming the gate hanger, by providing gate support, when the bolt apparatus is screwed into the steel mounting plate that is welded to the steel post support structure. An additional added feature and function of the upper three-dimensional bolt apparatus is functioning as a gate leveling device when the gate is in a vertical position, by screwing the device inward to elevate the gate's tongue tip, or screwing the device outward to lower the gate's tongue tip, and upon obtaining gate level, a jam nut secures the bolt apparatus into position, and
a heavy duty, gate hanger—mounting plate for a steel post, as shown and described in FIGS. #1, #2, #7, 8 and #9 (#8 being a steel plate designed for a concrete column), comprising of a ¼″ steel plate of approximately W-3 ½″ X H-4 ¼″ with a threaded center port and welded nut attached thereto, to extend the length of threaded surface, thus, increasing pull strength integrity and surface support integrity. Said steel mounting plate, with raised area facing inward into the steel post, for flush mounting, and welded thereto, thus, becoming the final piece part in the gate hinging process, and providing for the attachment of the gate hanger—three-dimensional bolt apparatus, and the lateral and pull strength support thereto.

2. The gate hanger—hinging kit/process of claim 1 wherein all of the independent and inter-related hardware piece part components are designed, and engineered to be used with each other, in the sequence, as shown and described in FIG. #2, for the proper hinging and support of such large, heavy, long tongue residential and or commercial ingress/egress security swing gates.
